(19) United States
(12) Patent Application Publication
(10) Pub. No.: US 2007/0169078 A1
(43) Pub. Date: Jul. 19, 2007

(54) Method of controlling automatic updating of software or hardware kit for multimedia display device

(75) Inventor: Meng-Gung Li, Taipei (TW)

Correspondence Address: BIRCH STEWART KOLASCH & BIRCH, PO BOX 747, FALLS CHURCH, VA, 22040-0747, US

(73) Assignee: KatDc Limited

(21) Appl. No.: 11/263,833

(22) Filed: Nov. 2, 2005

(51) Int. Cl. G06F 9/44

(52) U.S. Cl. 717/168

(57) ABSTRACT

In a method of controlling automatic updating of software or hardware kit for multimedia display device, when desired software or hardware is installed on or removed from a multimedia display device, the multimedia display device is caused to proceed with detection of newly increased software or hardware, and an end user is prompted to follow instructions shown on a screen of the display device to enter into a subsystem of the display device to proceed with procedures of driving the new software or hardware. The newly increased software kit may work immediately without the need of rebooting the display device. In the event a hardware driver is required, the display device is caused to reboot immediately, and an index data interface of the display device is automatically updated, so that a kit icon representing the new software or hardware is shown on or deleted from an index menu.

### FIELD OF THE INVENTION

The present invention relates to a method of controlling automatic updating of software or hardware kit for multimedia display device, and more particularly to a method that enables a multimedia display device to automatically update required software or hardware kit and show a kit icon representing the increased software or hardware on an index menu on a screen of the multimedia display device.

### BACKGROUND OF THE INVENTION

For a multimedia product to provide different functions, such as being a home audio/video center, supporting digital media, playing interactive programs, etc., most multimedia product manufacturers would try to develop unique application systems to achieve the above-mentioned functions. However, these unique application systems developed by different manufacturers are not compatible with one another to allow integrated use of the multimedia products made by these manufacturers. Users have to increase new software or hardware by themselves in practical use of these multimedia products.

According to the conventional techniques for a user to increase new software or hardware, the user has to manually upgrade the updated software or hardware. After the upgrade, all the related menus, programs, or even systems must be reinstalled and set up again. The reinstallation and setting up of new software and hardware involves very complicate procedures and systems, which are difficult to handle for general users who do not have sufficient related technical background. Therefore, the currently available methods for increasing new software or hardware could not satisfy most consumers' need in practical using of these methods.

### SUMMARY OF THE INVENTION

A primary object of the present invention is to provide a method that enables a multimedia display device to automatically update required software or hardware kit and show a kit icon representing the increased software or hardware on an index menu on a screen of the multimedia display device.

To achieve the above and other objects, a method of controlling automatic updating of software or hardware kit for multimedia display device includes the following steps: (a) to install or remove desired software or hardware on or from a multimedia display device, and cause the multimedia display device to proceed with detection of newly increased software or hardware; (b) to prompt an end user to follow instructions shown on a screen of the display device to enter in to a subsystem of the display device to proceed with procedures of driving the new software or hardware; and (c) in the event a hardware driver is required, the display device is caused to reboot immediately, and an index data interface of the display device is automatically updated, so that a kit icon representing the new software or hardware is shown on or deleted from an index menu; and if no hardware driver is required, the newly increased software kit may work immediately without the need of rebooting the display device.

With the method of the present invention, a multimedia display device can automatically update required software or hardware kit and show the kit icon on the index menu whenever there is new software or hardware increased to the multimedia display device.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in the method of the present invention; and

FIG. 2 is a schematic view showing the updating of an index menu in the method of the present invention.

### DETAILED DESCRIPTION OF THE PREFERRED EMBODIMENTS

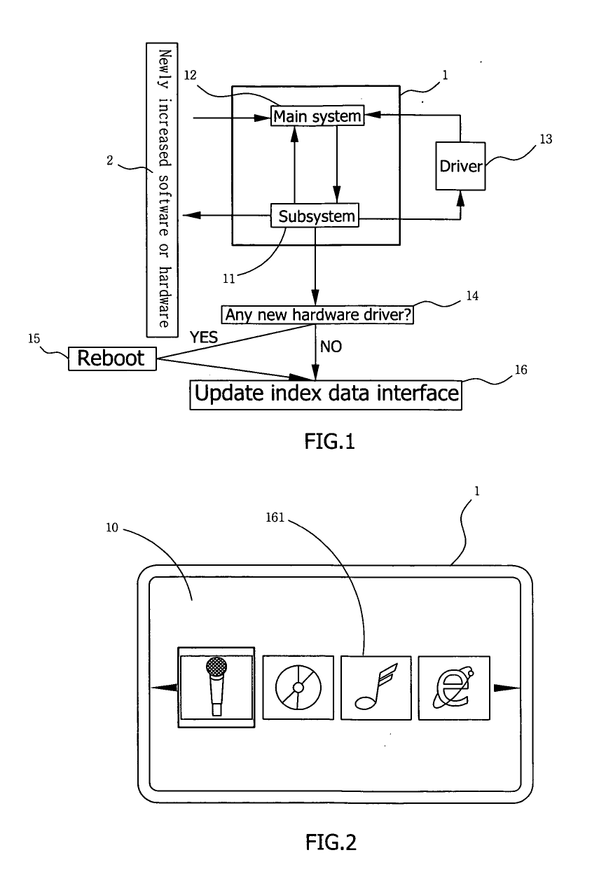

Please refer to FIG. 1 that is a flowchart showing the steps included in a method of controlling automatic updating of software or hardware kit for multimedia display device according to a preferred embodiment of the present invention, and to FIG. 2 that schematically shows the updating of an index menu in the method of the present invention. As shown in FIG. 1, the method of the present invention includes the following steps:
a. Install or remove required or desired software or hardware on or from a multimedia display device 1, so that a subsystem 11 of the multimedia display device 1 is actuated to proceed with a detection of any newly increased software or hardware 2. Wherein, the multimedia display device 1 may be a digital television set, or any kind of electronic device having a screen 10, such as a personal media player, or an electronic device electrically connected to a display for use with the display, such as a Set-top Box.
b. When the subsystem 11 detects any newly increased software or hardware 2, an end user is prompted to follow instructions shown on a screen of the multimedia display device 1 to enter into the subsystem 11 of the display device 1. The end user may then proceed with the increase of new software or hardware 2 and download of related driver 13 via a hardware expansion interface built in a main system 12 of the multimedia display device 1 or linking to the Internet.
c. When the newly increased software or hardware 2 has been driven to work, the subsystem 11 would determine whether there is any new hardware driver 14. If it is determined there is new hardware driver 14, the multimedia display device 1 is caused to reboot 15 immediately and automatically update an index data interface 16 thereof, so that a kit icon representing the new software or hardware 2 is shown on or deleted from an index menu 161. If it is determined there is not new hardware driver 14, the index data interface 16 is automatically updated, so that a kit icon representing the new software or hardware 2 is shown on or deleted from the index menu 161.

Through utilization of the principle of modularized software or hardware kit and the property of system separation at the application layer to achieve many commercially valuable applications, such as flexible system, value-added service upgrade, system peripheral optimization, unlimited software kit update, etc., the present invention allows the index data interface 16 on any multimedia display device, the index menu 161 of the index data interface 16, and the items in the index menu 161 to be automatically updated whenever any hardware module or software function of the multimedia display device 1 is expanded, upgraded, subscribed, downloaded, increased, or decreased; and the automatic increase or deletion of related kit icon on or from the index data interface 16. The present invention not only provides system service providers, interactive TV service providers, consumptive electronic product dealers, and digital household appliance dealers with the benefits of upgraded product functions and value-added operation, but also has good potential in the markets of interactive web service, digital home environment architecture, digital content distribution platform, etc.

In conclusion, the method of controlling automatic updating of software or hardware kit for multimedia display device according to the present invention allows a multimedia display device to automatically update required software or hardware kit and show the kit icon on the index menu whenever there is new software or hardware increased to the multimedia display device, making the multimedia display device more practical for use to meet most consumers' requirements.

The present invention has been described with a preferred embodiment thereof and it is understood that many changes and modifications in the described embodiment can be carried out without departing from the scope and the spirit of the invention that is intended to be limited only by the appended claims.

What is claimed is:

1. A method of controlling automatic updating of software or hardware kit for multimedia display device, comprising the following steps:
a. Installing or removing desired software or hardware on or from a multimedia display device, and causing said multimedia display device to proceed with detection of any newly increased software or hardware;
b. When any newly increased software or hardware is detected, prompting an end user to follow instructions shown on a screen of said multimedia display device to enter into a subsystem of said multimedia display device, so as to proceed with procedures of driving said newly increased software or hardware; and
c. When said newly increased software or hardware has been driven to work, determining whether there is related new hardware driver or not; if yes, causing said multimedia display device to reboot immediately and automatically update an index data interface thereof, so that a kit icon representing said newly increased software of hardware is shown on or deleted from an index menu of said index data interface; or, if no, causing said index data interface to automatically update, so that a kit icon representing said newly increased software of hardware is shown on or deleted from an index menu of said index data interface.

2. The method of controlling automatic updating of software or hardware kit for multimedia display device as claimed in claim 1, wherein said multimedia display device is a digital television set.

3. The method of controlling automatic updating of software or hardware kit for multimedia display device as claimed in claim 1, wherein said multimedia display device is a personal media player.

4. The method of controlling automatic updating of software or hardware kit for multimedia display device as claimed in claim 1, wherein said multimedia display device is an electronic device having a screen.

5. The method of controlling automatic updating of software or hardware kit for multimedia display device as claimed in claim 1, wherein said multimedia display device is an electronic device electrically connected to a display.

6. The method of controlling automatic updating of software or hardware kit for multimedia display device as claimed in claim 1, wherein the installation or removal of said desired software or hardware on or from said multimedia display device in the step (a) is conducted via a hardware expansion interface built in a main system of said multimedia display device.

7. The method of controlling automatic updating of software or hardware kit for multimedia display device as claimed in claim 1, wherein the installation or removal of said desired software or hardware on or from said multimedia display device in the step (a) is conducted through linking to the Internet.

8. The method of controlling automatic updating of software or hardware kit for multimedia display device as claimed in claim 1, wherein the detection of any newly increased software or hardware in the step (a) is conducted by a subsystem of said multimedia display device.

9. The method of controlling automatic updating of software or hardware kit for multimedia display device as claimed in claim 1, wherein said newly increased software is a web system service.

10. The method of controlling automatic updating of software or hardware kit for multimedia display device as claimed in claim 9, wherein said web system service is a pay service subscription.

11. The method of controlling automatic updating of software or hardware kit for multimedia display device as claimed in claim 1, wherein said newly increased software is an interactive TV service.

12. The method of controlling automatic updating of software or hardware kit for multimedia display device as claimed in claim 11, wherein said interactive TV service is a pay file download service.
